(19) United States
(12) Patent Application Publication
(10) Pub. No.: US 2025/0290825 A1
(43) Pub. Date: Sep. 18, 2025

(54) DAMAGE DETECTION APPARATUS, DAMAGE DETECTION SYSTEM AND DAMAGE DETECTION METHOD

(71) Applicant: KABUSHIKI KAISHA TOSHIBA, Tokyo (JP)

(72) Inventors: Takashi USUI, Saitama Saitama (JP); Hidefumi TAKAMINE, Shinagawa Tokyo (JP); Yuki UEDA, Yokohama Kanagawa (JP); Kazuo WATABE, Yokohama Kanagawa (JP)

(73) Assignee: KABUSHIKI KAISHA TOSHIBA, Tokyo (JP)

(21) Appl. No.: 19/051,324

(22) Filed: Feb. 12, 2025

(30) Foreign Application Priority Data
Mar. 15, 2024 (JP) 2024-041635

(51) Int. Cl. G01M 5/00; G01M 7/08

(52) U.S. Cl. CPC G01M 5/0066; G01M 5/0033; G01M 7/08

(57) ABSTRACT

According to one embodiment, a damage detection apparatus according to an embodiment includes a detector, a spectrum calculator, and a depth calculator. The detector detects an Alternating Current (AC) component of an envelope using one or more elastic waves generated by an impact on a structure. The spectrum calculator calculates a frequency spectrum based on the detected AC component of the envelope. The depth calculator calculates a depth of damage inside the structure based on the frequency spectrum.

### CROSS-REFERENCE TO RELATED APPLICATION

This application is based upon and claims the benefit of priority from Japanese Patent Application No. 2024-041635, filed Mar. 15 2024, the entire contents of which are incorporated herein by reference.

### FIELD

Embodiments described herein relate generally to a damage detection apparatus, a damage detection system and a damage detection method.

### BACKGROUND

In recent years, problems resulting from deterioration of industrial devices and structures have become obvious. Since the damage caused by accidents occurring in industrial devices and structures is immeasurable, technologies for monitoring the states of industrial devices and structures have been developed in the past. Particularly, inspection methods using elastic waves have been proposed in order to detect damage inside a concrete structure and the depth of the damage. As inspection methods using elastic waves, an impact echo method in which a predetermined impact is applied to a concrete structure, and the depth of damage is detected based on a peak frequency of a spectrum of the elastic wave generated by the applied impact is known.

Non-Patent Document 1 discloses the principle of the impact echo (IE) method. In addition, Patent Document 1 discloses a method of visualizing the internal damage using the principle of the impact echo method. In a method of estimating the depth of damage based on the peak frequency due to longitudinal wave resonance of impact elastic waves and a known velocity, a dedicated sensor with flat frequency characteristics in a frequency range from a low frequency band to an acceleration sensor band is required. Therefore, it was not possible to use high-frequency sensors (for example, an acoustic emission (AE) sensor) with unknown frequency characteristics in an accurate acceleration sensor band or low-cost sensors that have not been accurately calibrated.

As described above, a dedicated sensor is required in order to estimate the depth of damage, which is thought to increase costs. Thus, in the past, sensors used to estimate the depth of damage were sometimes limited to dedicated sensors.

### BRIEF DESCRIPTION OF THE DRAWINGS

FIG. 1A is a diagram showing the waveform of the elastic wave detected by the AE sensor.

FIG. 1B is a diagram showing the waveform of the elastic wave detected by the sensor used in the impact echo method.

FIG. 1C is a diagram showing the frequency spectrum of the elastic wave detected by the AE sensor.

FIG. 1D is a diagram showing the frequency spectrum of the elastic wave detected by the sensor used in the impact echo method.

FIG. 2 is a diagram showing the simulation results of observed signals.

FIG. 3 is a diagram showing a configuration of a damage detection system in a first embodiment.

FIG. 4 is a diagram showing a configuration example of a signal processor in the first embodiment.

FIG. 5 is a diagram for illustrating the difference between a conventional band pass filter and a filter in the first embodiment.

FIG. 6A is a diagram showing the relationship between the true reflection frequency when the center frequency fc is 20 kHz and the reflection frequency estimated by the method in the embodiment.

FIG. 6B is a diagram showing the relationship between the true reflection frequency when the center frequency f_{c} is 30 kHz and the reflection frequency estimated by the method in the embodiment.

FIG. 6C is a diagram showing the relationship between the true reflection frequency when the center frequency f_{c} is 40 kHz and the reflection frequency estimated by the method in the embodiment.

FIG. 6D is a diagram showing the relationship between the true reflection frequency when the center frequency f_{c} is 50 kHz and the reflection frequency estimated by the method in the embodiment.

FIG. 7A is a diagram showing the relationship between the true reflection frequency when the bandwidth BW is 100 Hz and the reflection frequency estimated by the method in the embodiment.

FIG. 7B is a diagram showing the relationship between the true reflection frequency when the bandwidth BW is 1 kHz and the reflection frequency estimated by the method in the embodiment.

FIG. 7C is a diagram showing the relationship between the true reflection frequency when the bandwidth BW is 100 Hz and the reflection frequency estimated by the method in the embodiment.

FIG. 7D is a diagram showing the relationship between the true reflection frequency when the bandwidth BW is 20 kHz and the reflection frequency estimated by the method in the embodiment.

FIG. 8 is a diagram showing the detection results of a reflection frequency according to a center frequency f_{c} of the filter in the first embodiment.

FIG. 9 is a flowchart showing a flow of a damage detection process performed by a damage detection apparatus in the first embodiment.

FIG. 10A is a diagram showing the waveform data at a certain measurement point.

FIG. 10B is a diagram showing the waveform data obtained by filtering process.

FIG. 10C is a diagram showing the waveform data obtained by squaring process.

FIG. 10D is a diagram showing the waveform data obtained by filtering process.

FIG. 10E is a diagram showing the frequency spectrum obtained from the waveform data. FIG. 11A is a diagram showing the frequency spectrum obtained by the method in the embodiment.

FIG. 11B is a diagram showing the frequency spectrum obtained by the conventional impact echo method.

FIG. 12 is a diagram showing a configuration of a damage detection system in a second embodiment.

FIG. 13 is a diagram showing a configuration example of a signal processor in the second embodiment.

### DETAILED DESCRIPTION

The present invention provides a damage detection apparatus, a damage detection system and a damage detection method through which it is possible to improve the degrees of freedom of a sensor used to estimate the depth of damage and reduce sensor costs.

According to one embodiment, a damage detection apparatus according to an embodiment includes a detector, a spectrum calculator, and a depth calculator. The detector detects an Alternating Current (AC) component of an envelope using one or more elastic waves generated by an impact on a structure. The spectrum calculator calculates a frequency spectrum based on the detected AC component of the envelope. The depth calculator calculates the depth of damage inside the structure based on the frequency spectrum.

Hereinafter, a damage detection apparatus, a damage detection system and a damage detection method according to embodiments will be described with reference to the drawings.

### (Principle of Estimating Depth of Damage Using Multiple Reflections)

First, before describing the contents of the embodiments, the principle of estimating the depth of damage using multiple reflections will be described. In the related art, a depth estimation method using multiple reflections of elastic waves as shown in Non-Patent Document 1 has been proposed as a method of estimating the depth of damage. The depth of damage is the depth from a certain surface (for example, the surface of the structure) to the position of damage inside the structure. In the following description, the depth from the surface where an impact is applied to a structure to the position of damage will be referred to as the depth of damage.

In the method described in Non-Patent Document 1, when an impact with a sufficiently wide band and strong strength is applied to a structure, an elastic wave is generated inside the structure. The elastic wave generated inside the structure undergoes multiple reflections at internal gaps of the structure and at the interface with air. When the velocity of the elastic wave propagating inside the structure (elastic wave velocity) is Cₚ, in a vibration waveform detected by a sensor installed on the surface of the structure, a peak appears with a period of travel time Δt when the wave propagates at the elastic wave velocity Cₚ over a distance twice the plate thickness T of the structure. Therefore, the frequency f of the observed vibration is expressed as the following Formula (1).

$$\begin{matrix}[ Math . 1 ] & \\ f = \frac{1}{Δ t} = \frac{{C}_{p}}{2 T} & ( 1 )\end{matrix}$$

That is, when the elastic wave velocity Cₚ is known, the depth T at which reflection occurs is expressed by the following Formula (2).

$$\begin{matrix}[ Math . 2 ] & \\ T = \frac{{C}_{p}}{2 f} & ( 2 )\end{matrix}$$

In Formula (2), the frequency f can be determined by performing a fast Fourier transform (FFT) on the vibration waveform observed by the sensor. Other methods such as a maximum entropy method (MEM) may be used to calculate the frequency f.

The method described in Non-Patent Document 1 is based on the assumption that frequency characteristics of the sensor are flat. However, there are cases in which frequency characteristics of the sensor are not flat. When frequency characteristics of the sensor are not flat, the spectrum of the time-series vibration waveform observed by the sensor is a spectrum in which unknown frequency characteristics of the sensor are added to the frequency spectrum of the elastic wave. Unless the frequency spectrum of the sensor is known in advance, the frequency spectrum of the elastic wave is also unknown. It is clear that, in the method described in Non-Patent Document 1, a sensor with flat frequency characteristics is implicitly assumed, and thus the spectrum of the time-series vibration waveform observed by the sensor is assumed to match the frequency spectrum of the elastic wave.

(when Sensor with Unknown Frequency Characteristics is Used: Example of AE Sensor)

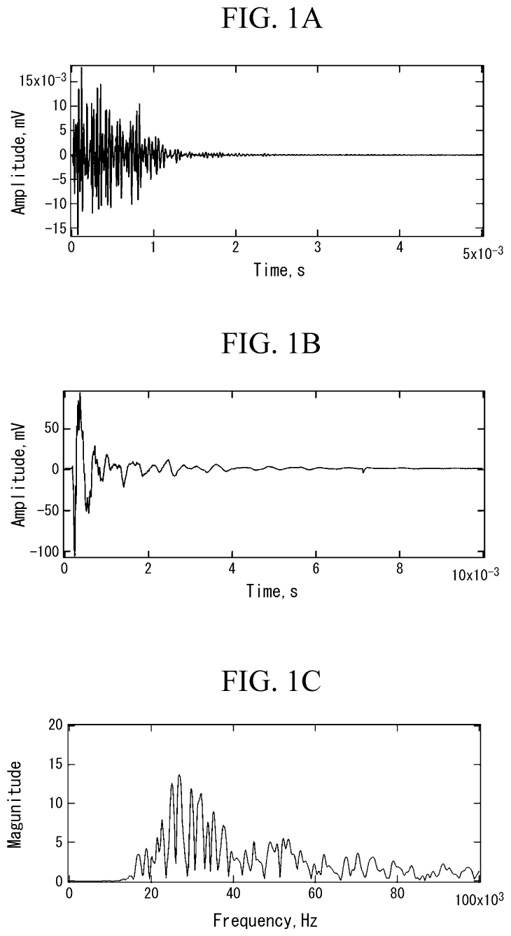

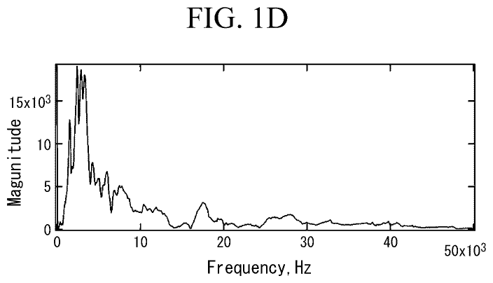

If sensors with unknown frequency characteristics are used, sensor options would be expanded, which is thought to be beneficial in terms of costs and convenience. A resonance type AE sensor is an example of a sensor with non-flat frequency characteristics. However, the frequency bands detected by the AE sensor and the sensor used in the impact echo method are different. Therefore, it is difficult to identify the reflection frequency using the signal detected by the AE sensor without change. This point will be described in detail with reference to FIG. 1A to FIG. 1D.

FIG. 1 shows diagrams for illustrating the difference between an AE sensor and a sensor used in an impact echo method. FIG. 1A shows the waveform of the elastic wave detected by the AE sensor, and FIG. 1B shows the waveform of the elastic wave detected by the sensor (displacement sensor) used in the impact echo method. In addition, FIG. 1C shows the frequency spectrum of the elastic wave detected by the AE sensor, and FIG. 1D shows the frequency spectrum of the elastic wave detected by the sensor used in the impact echo method. Here, FIG. 1A) and FIG. 1B show the elastic wave obtained by applying an impact to the same location on a concrete structure with a thickness of 0.36 m by hitting a steel ball.

As shown in FIG. 1A and FIG. 1B, it can be understood that, even though the two sensors receive substantially the same elastic wave, the detected waveforms are significantly different because the frequency characteristics of the sensors are different. This is due to the difference in frequency sensitivity characteristics between the AE sensor and the sensor used in the impact echo method. The AE sensor has sensitivity at a high frequency of 20 kHz or more and the sensor used in the impact echo method (displacement sensor) has a flat sensitivity characteristic in the low frequency range.

The multiple reflection frequency reflected from the surface on which the sensor is installed and the opposite surface in the plate thickness of the structure (the surface opposite to the surface on which the sensor is installed) should be about 3.5 kHz according to the relationship of Formula (1) when the plate thickness of the structure is 0.36 m, and the elastic wave velocity is 2,500 m/s. As shown in FIG. 1D, in the multiple reflection frequency obtained by the sensor used in the impact echo method (displacement sensor), a peak appears near about 3.5 kHz, indicating that a reflected signal from the opposite surface can be detected. On the other hand, as shown in FIG. 1C, in the spectrum of the AE sensor, a peak appears near 30 kHz, and it is not possible to identify the multiple reflection frequency from the peak frequency. That is, it can be understood that it is difficult to identify the multiple reflection frequency based on the signal detected by the AE sensor by a method based on a conventional impact echo method.

(Overview of this Method)

Next, a method for identifying the multiple reflection frequency using the AE sensor will be described. Here, in the following description, the AE sensor will be exemplified, but the present invention is not limited to the AE sensor, and other sensors may be used as long as they have unknown frequency characteristics. Here, an impact from hitting a steel ball will be exemplified as an impact on a structure.

When the contact time of the steel ball is shorter, the time function of the impact strength is closer to the delta function, and the Fourier spectrum contains a wider range of frequency components. The contact time the of the steel ball can be determined using the diameter D of the steel ball based on the Herz contact theory, as shown in the following Formula (3).

$$\begin{matrix}[ Math . 3 ] & \\ {t}_{c} = 4.3 {e}^{- 3} \cdot D & ( 3 )\end{matrix}$$

Therefore, it can be understood that frequency characteristics of the elastic wave generated by hitting a steel ball depend on the diameter of the steel ball. In addition, the upper limit fₘₐₓ of the frequency is related to the diameter D of the steel ball by Sansalone et al. as shown in the following Formula (4).

$$\begin{matrix}[ Math . 4 ] & \\ {f}_{max} = 291 / D & ( 4 )\end{matrix}$$

As an example, when a steel ball with a diameter of 5 mm is used, the upper limit frequency is 58.2 kHz. This suggests that it contains a component with a frequency higher than the resonant frequency of 10 kHz to 50 kHz of the AE sensor used for concrete. Therefore, the inventors focused on detecting the excited elastic wave as a narrowband signal within a sensitivity range of the AE sensor.

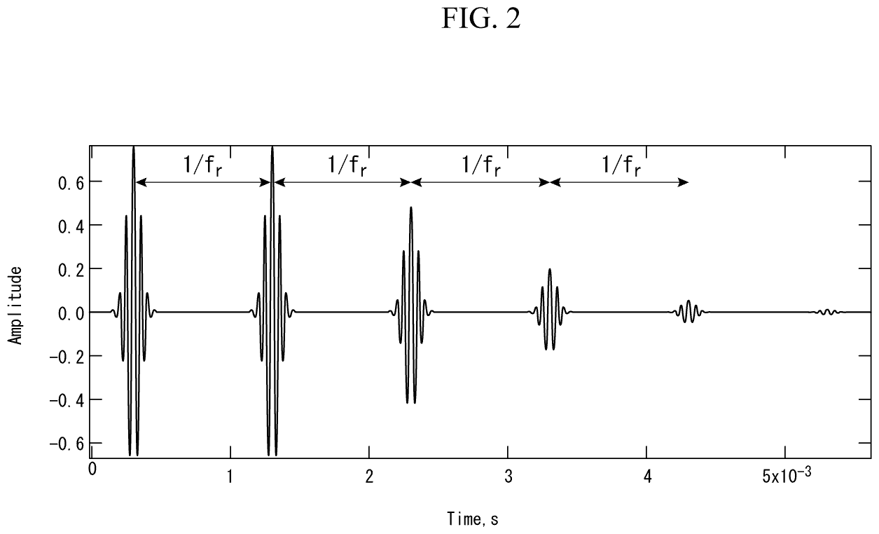

A case in which an elastic wave applied as a narrowband burst signal with a center frequency f_{c} undergoes multiple reflection on the applied surface and the opposite surface is considered. FIG. 2 shows the time waveform obtained by simulating observed signals. FIG. 2 is a diagram showing the simulation results of the observed signals. When the frequency of the signal that undergoes multiple reflection at the thickness Tᵣ is fᵣ, the burst signal is repeatedly observed while attenuating with a period of 1/fᵣ. Here, a case assuming fᵣ=1,000 Hz will be described.

First, in this method, an observed signal passed through a first band pass filter is treated as a narrowband signal. In this case, the center frequency of the first band pass filter is, for example, 20 kHz. This is a frequency that is sufficiently higher than the reflection frequency fᵣ, and it is necessary to be aware that the sensor does not need to have sensitivity in the band of the reflection frequency fᵣ. Next, a process of obtaining an absolute value or a square of the observed signal filtered by the first band pass filter is performed. Next, using a second band pass filter, an envelope of the observed signal is detected, and an AC component of the detected envelope is extracted. Here, the second band pass filter is a filter that passes 1 kHz to 10 kHz.

The second band pass filter may include a low-pass filter with a cutoff of 10 kHz for extracting an envelope and a high-pass filter with a cutoff of 1 kHz for cutting off a Direct Current (DC) component for extracting an AC component of an envelope, which are connected in series. Here, in the second band pass filter, a Hilbert transform can also be used in order to extract an envelope. In this case, the second band pass filter may include a converter configured to perform a Hilbert transform on the observed signal and a high-pass filter configured to remove a DC component of the envelope obtained by the Hilbert transform, which are connected in series.

Then, the AC component of the obtained envelope is subjected to a Fourier transform to obtain a reflection spectrum. The reflection spectrum contains a component with a reflection frequency fᵣ=1,000 Hz. The reflection spectrum is the same as a spectrum obtained by a sensor with low-frequency sensitivity, and can be treated in the same manner as a spectrum obtained by the conventional impact echo method. That is, based on the peak frequency of the reflection spectrum obtained by this procedure, the depth T of damage can be easily determined based on Formula (1). Here, the elastic wave velocity Cₚ is assumed to be known, but the elastic wave velocity Cₚ may be calculated by a conventional method.

The above is a flow of the process of the depth estimation method in the embodiment. A specific configuration for realizing the above process will be described below.

### First Embodiment

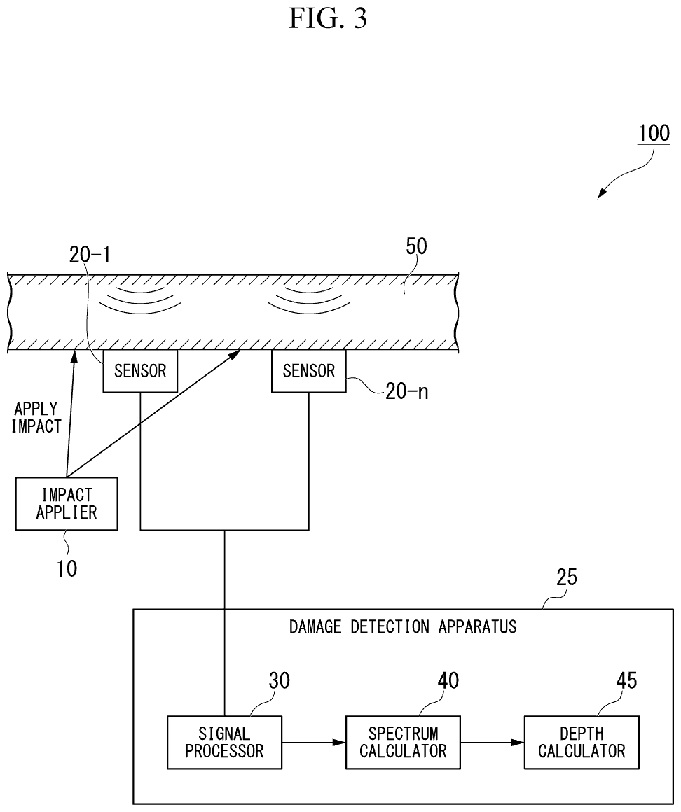

FIG. 3 is a diagram showing a configuration of a damage detection system 100 in a first embodiment. The damage detection system 100 is used to detect damage occurring inside a structure 50. The damage detection system 100 in the first embodiment detects at least the depth (depth of damage) of an area where damage has occurred inside the structure 50 (hereinafter referred to as a “damaged area”).

In the following description, a case in which the structure 50 is a bridge will be exemplified, but the structure 50 is not necessarily limited to the bridge. The structure 50 may be any structure in which an elastic wave is generated in response to the occurrence or progress of a crack or an external impact (for example, rain, artificial rain, etc.). Here, the bridge is not limited to structures built over rivers, valleys and the like, but also includes various structures (for example, expressway viaducts) that are provided above the ground. Here, the damage detection target is not particularly limited as long as it is a plate-like member and not a structure.

The damage detection system 100 includes an impact applier 10, one or more sensors 20-1 to 20-n (n is an integer of 1 or more), and a damage detection apparatus 25. The sensors 20-1 to 20-n are each connected to the damage detection apparatus 25 in a wired manner so that they can communicate with each other. Here, in the following description, when the sensors 20-1 to 20-n are not distinguished, they will be described as the sensor 20.

For example, the impact applier 10 is installed on the same surface on which the sensor 20 is installed and applies an impact to the structure 50. The impact applier 10 applies an impact to the structure 50, for example, by hitting the structure 50. As described above, it is desirable for the impact applier 10 to apply an impact that can generate a signal having a high frequency which can be detected by the AE sensor.

Here, the method by which the impact applier 10 applies an impact to the structure 50 is not limited to using a steel ball, and any other impact may be applied to the structure 50 as long as it is an impact that can generate a signal having a high frequency which can be detected by the AE sensor. The impact applier 10 applies an impact to the structure 50, for example, using a steel ball, core pressure folding, or pulse excitation using a piezoelectric element. The impact applier 10 may be installed on a surface different from the surface on which the sensor 20 is installed. The surface different from the surface on which the sensor 20 is installed is, for example, the surface opposite to the surface on which the sensor 20 is installed, a side surface of the structure 50 or the like.

Even if the impact applier 10 is installed on the surface different from the surface on which the sensor 20 is installed, the impact applier 10 applies an impact to generate an elastic wave, and the generated elastic wave undergoes multiple reflection and can be detected by the sensor 20. Therefore, the same effect as when the impact applier 10 is installed on the same surface on which the sensor 20 is installed can be obtained.

The sensor 20 has a piezoelectric element, and detects an elastic wave reflected at the inside or the end surface of the structure 50. The sensor 20 is installed at a position on the surface of the structure 50 at which it can detect an elastic wave. For example, the sensors 20-1 to 20-n are installed on the road surface, the side surface or the bottom surface and separated at equal or different intervals in the vehicle travel axis direction and in the direction perpendicular to the vehicle travel axis. The vehicle travel axis direction is a direction in which a vehicle travels on the road surface. The direction perpendicular to the vehicle travel axis is a direction perpendicular to the vehicle travel axis direction. The sensor 20 converts the detected elastic wave into an electrical signal. In the following description, a case in which the sensor 20 is installed on the bottom surface of the structure 50 will be exemplified.

In the sensor 20, for example, a piezoelectric element having sensitivity in a range of 10 kHz to 1 MHz is used. The sensor 20 may be of any of a resonance type having a resonance peak within a frequency range and a resonance-suppressed broadband type, but any type of the sensor 20 may be used. The method by which the sensor 20 detects an elastic wave includes a voltage output method, a resistance change method, a capacitance method and the like, and any detection method may be used. The sensor 20 is, for example, an AE sensor.

Here, the sensor 20 is not limited to the AE sensor, and other sensors may be used as long as they are sensors with unknown frequency characteristics. For example, an acceleration sensor may be used in place of the sensor 20. In this case, the acceleration sensor detects an elastic wave generated inside the structure 50. Then, the acceleration sensor performs the same process as the sensor 20 and thus converts the detected elastic wave into an electrical signal.

The damage detection apparatus 25 detects at least the depth of damage inside the structure 50 based on the elastic wave detected by each sensor 20. The damage detection apparatus 25 includes a signal processor 30, a spectrum calculator 40, and a depth calculator 45. FIG. 3 shows the signal processor 30, the spectrum calculator 40, and the depth calculator 45 that are included in one housing, but the signal processor 30, the spectrum calculator 40 and the depth calculator 45 may be installed in a nearby location or in a remote location. For example, the spectrum calculator 40 and the depth calculator 45 may be provided in an information processing apparatus as one function of a personal computer or the like. When the spectrum calculator 40 and the depth calculator 45 are provided as one function of the information processing apparatus, the spectrum calculator 40 and the depth calculator 45 are functions that are realized by executing a program. In this case, the signal processor 30 and the information processing apparatus are connected in a wired or wireless manner so that they can communicate with each other.

The signal processor 30 receives the electrical signal output from the sensor 20. The signal processor 30 performs signal processing on the received electrical signal. The signal processing performed by the signal processor 30 is, for example, detection of an AC component of an envelope. The signal processor 30 outputs information indicating the detected AC component of the envelope to the spectrum calculator 40.

The signal processor 30 includes a digital circuit. The digital circuit is realized by, for example, a field programmable gate array (FPGA) or a microcomputer. The digital circuit may be realized by a dedicated large-scale integration (LSI). In addition, in the signal processor 30, a non-volatile memory such as a flash memory or a removable memory may be installed. In the following description, a case in which the signal processor 30 includes a digital circuit will be described.

The spectrum calculator 40 receives information indicating an AC component of an envelope output from the signal processor 30. The spectrum calculator 40 calculates a frequency spectrum based on the received information indicating the AC component of the envelope.

The depth calculator 45 calculates, based on the frequency spectrum calculated by the spectrum calculator 40, the depth of damage inside the structure 50, which occurs inside the structure 50.

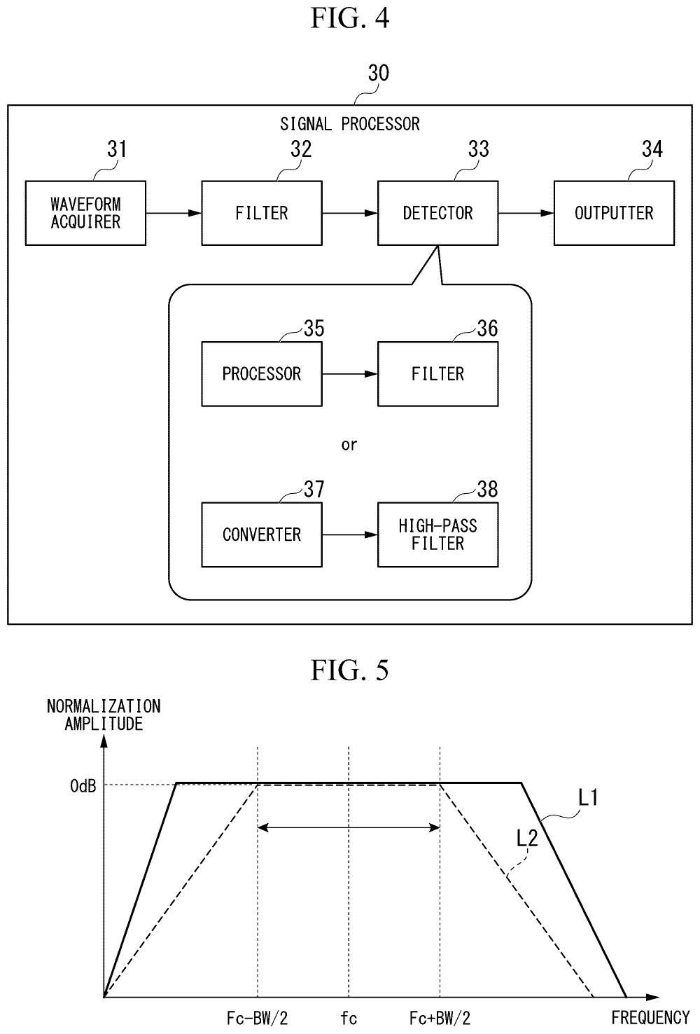

FIG. 4 is a diagram showing a configuration example of the signal processor 30 in the first embodiment. The signal processor 30 includes a waveform acquirer 31, a filter 32, a detector 33, and an outputter 34.

The waveform acquirer 31 includes an amplifier, an analog filter, and an analog-to-digital converting unit. The amplifier amplifies the electrical signal (analog signal) output from the sensor 20 to the extent that it can be processed in the analog-to-digital converting unit. The amplifier outputs the amplified electrical signal to the analog filter. The analog filter removes a noise component outside a predetermined band. The analog filter is, for example, a band pass filter (BPF). Regarding the band pass filter used here, it is desirable to use a filter having a pass bandwidth wide enough not to distort the shape of the elastic wave (AE signal). The electrical signal from which noise has been removed by the analog filter is input to the analog-to-digital converting unit. The analog-to-digital converting unit quantizes the noise-removed electrical signal and converts it into a digital signal. The analog-to-digital converting unit outputs waveform data, which is a digital signal, to the filter 32.

The filter 32 performs a filtering process on the waveform data output from the waveform acquirer 31 and converts the waveform data into a narrowband signal. The filter 32 is a band pass filter, and for example, has a center frequency set to a frequency higher than the reflection frequency fᵣ (fᵣ−Cₚ/2T) calculated based on the thickness T of the structure 50 and the propagation velocity Cₚ of the elastic wave propagating inside the structure 50. Here, it is necessary to be aware that the sensor 20 does not need to have sensitivity in the band of the reflection frequency fᵣ.

The filter 32 can switch the center frequency and the bandwidth in response to an external instruction. For example, the center frequency of the filter 32 is switched according to the depth of damage. In addition, the bandwidth of the filter 32 is desirably 100 Hz or more. The filter 32 is one form of the first band pass filter.

The detector 33 detects an AC component of an envelope using the waveform data (narrowband signal) filtered by the filter 32. The detector 33 includes, for example, a processor 35 and a filter 36. The processor 35 performs a process of obtaining an absolute value or a square of the filtered waveform data. The filtered waveform data is data having amplitudes in positive and negative directions. Therefore, the waveform data filtered by the process performed by the processor 35 is converted into data having an amplitude in the positive direction.

The filter 36 detects an envelope using the waveform data processed by the processor 35 and detects an AC component of the detected envelope. The filter 36 is a band pass filter, and passes, for example, a lower frequency band than the filter 32. The filter 36 passes, for example, a frequency band of 1 kHz to 10 kHz. The filter 36 may include a low-pass filter and a high-pass filter connected in series. In this case, the low-pass filter is a filter with a cutoff frequency (for example, 10 kHz) set for extracting an envelope, and the high-pass filter is a filter with a cutoff frequency (for example, 1 kHz) set for cutting off a DC component for extracting an AC component of an envelope. The filter 36 is one form of the second band pass filter.

The detector 33 may include a combination of a converter 37 and a high-pass filter 38 in place of a combination of the processor 35 and the filter 36. The converter 37 performs a Hilbert transform on the waveform data processed by the processor 35. The high-pass filter 38 is a filter with a cutoff frequency set for cutting off a DC component of the envelope obtained by the converter 37.

The outputter 34 generates transmission data including information indicating the AC component of the envelope extracted by the detector 33. The outputter 34 transmits the generated transmission data to the spectrum calculator 40 in a wired or wireless manner.

FIG. 5 is a diagram for illustrating the difference between a conventional band pass filter and the filter 32 in the first embodiment. In FIG. 5, the line segment L1 indicates a frequency band through which the conventional band pass filter passes, and the line segment L2 indicates a frequency band through which the filter 32 passes. The conventional band pass filter passes a frequency band in a relatively wide range in order to remove noise, and on the other hand, the filter 32 passes a frequency band in a relatively narrow range in order to convert waveform data into a narrowband signal. As shown in FIG. 5, the filter 32 passes a frequency band in the range of Fc−(BW/2) to Fc+(BW/2) with the center frequency f_{c} as a reference. Here, Fc indicates the center frequency, and BW indicates the bandwidth.

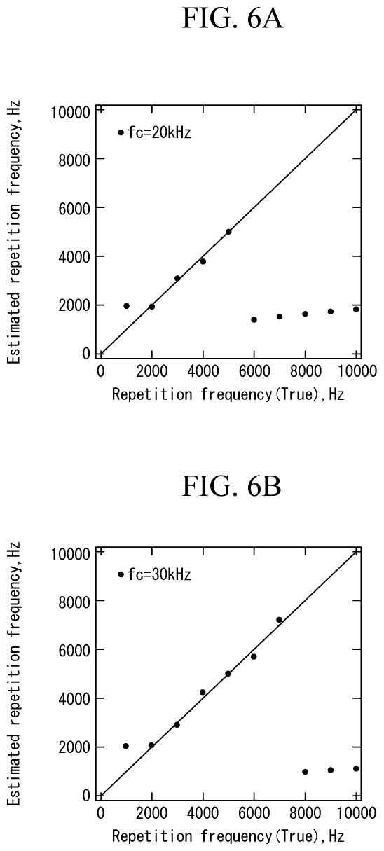

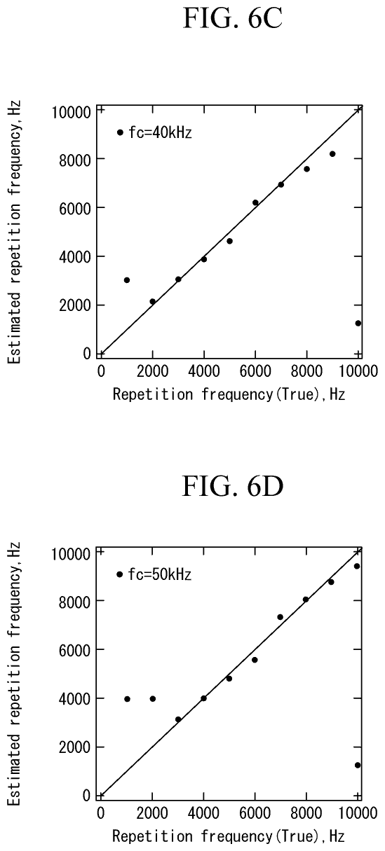

Next, the dependence of filter characteristics of the filter 32 will be described with reference to FIG. 6. FIG. 6 shows diagrams for illustrating the dependence of filter characteristics of the filter 32 in the first embodiment. In FIG. 6A to FIG. 6D, the horizontal axis represents the true reflection frequency, and the vertical axis represents the reflection frequency estimated by the method in the embodiment. FIG. 6A to FIG. 6D show the relationship between the true reflection frequency and the reflection frequency estimated by the method in the embodiment when the center frequency f_{c} of the filter 32 is increased in the order of FIG. 6A to FIG. 6D.

FIG. 6A shows the relationship between the true reflection frequency when the center frequency f_{c} is 20 kHz and the reflection frequency estimated by the method in the embodiment. FIG. 6B shows the relationship between the true reflection frequency when the center frequency f_{c} is 30 kHz and the reflection frequency estimated by the method in the embodiment. FIG. 6C shows the relationship between the true reflection frequency when the center frequency f_{c} is 40 kHz and the reflection frequency estimated by the method in the embodiment. FIG. 6D shows the relationship between the true reflection frequency when the center frequency f_{c} is 50 kHz and the reflection frequency estimated by the method in the embodiment.

As shown in FIG. 6A to FIG. 6D, it can be understood that, when the center frequency f_{c} is higher, a reflection spectrum with a higher frequency can be detected. Therefore, it is desirable to set the center frequency f_{c} of the filter 32 according to the reflection spectrum to be detected. Here, since scattering or attenuation is stronger as the frequency is higher, it is desirable to set the center frequency f_{c} to a minimum frequency within a required range.

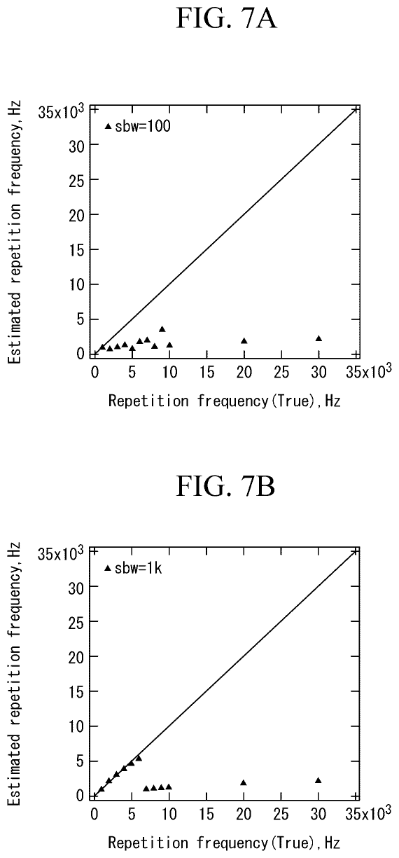

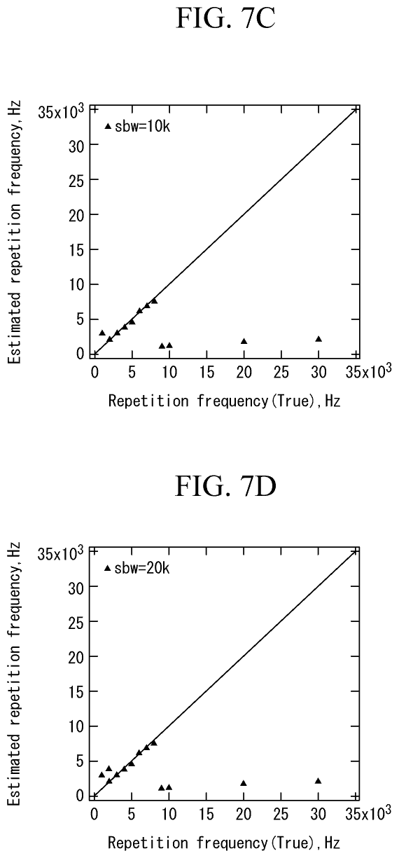

Next, the dependence of bandwidth characteristics of the filter 32 will be described. FIG. 7 shows diagrams for illustrating the dependence of bandwidth characteristics of the filter 32 in the first embodiment. In FIG. 7A to FIG. 7D, the horizontal axis represents the true reflection frequency, and the vertical axis represents the reflection frequency estimated by the method in the embodiment. FIG. 7A to FIG. 7D show the relationship between the true reflection frequency and the reflection frequency estimated by the method in the embodiment when the bandwidth BW of the filter 32 is increased in the order of FIG. 7A to FIG. 7D.

FIG. 7A shows the relationship between the true reflection frequency when the bandwidth BW is 100 Hz and the reflection frequency estimated by the method in the embodiment. FIG. 7B shows the relationship between the true reflection frequency when the bandwidth BW is 1 kHz and the reflection frequency estimated by the method in the embodiment. FIG. 7C shows the relationship between the true reflection frequency when the bandwidth BW is 100 Hz and the reflection frequency estimated by the method in the embodiment. FIG. 7D shows the relationship between the true reflection frequency when the bandwidth BW is 20 kHz and the reflection frequency estimated by the method in the embodiment. Here, in FIG. 7A to FIG. 7D, as an example, a case in which center frequency f_{c} of the filter 32 is 40 kHz is shown.

As shown in FIG. 7A to FIG. 7D, it can be understood that, when the bandwidth BW is narrowed (the bandwidth BW is reduced), the detection range shifts to the low-frequency side, and when it is narrowed to about 100 Hz (for example, FIG. 7A), detection is not possible. Therefore, the bandwidth BW of the filter 32 is desirably 100 Hz or more.

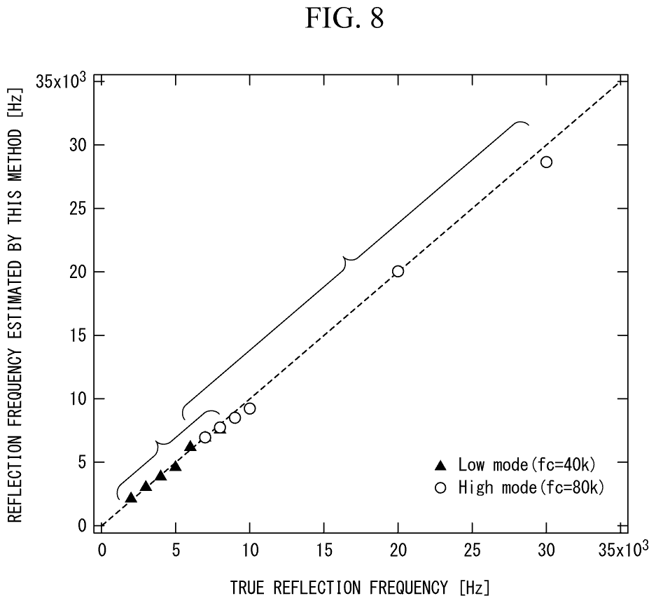

Based on the results shown in FIG. 6 and FIG. 7, as shown in FIG. 8, it can be understood that, by switching the center frequency f_{c} of the filter 32, the reflection frequency can be correctly estimated in a wide range. Here, a simulation assuming various depths of damage is performed, and the results of estimating the depth of damage by this method are shown in FIG. 8. FIG. 8 shows an example in which, using a depth of about 0.15 m as a boundary, when an area shallower than the boundary is measured, the center frequency of the filter 32 is 80 kHz, and when an area deeper than the boundary is measured, the center frequency is 40 kHz. In FIG. 8, the horizontal axis represents the true depth of damage assumed in the simulation, and the vertical axis represents the depth estimated by this method. FIG. 8 is a diagram showing the detection results of a reflection frequency according to a center frequency f_{c} of the filter 32 in the first embodiment.

As shown in FIG. 8, it can be understood that, when the center frequency f_{c} of the filter 32 is 40 kHz (low mode shown in FIG. 8), the low-frequency reflection frequency can be detected with high accuracy, and when the center frequency f_{c} of the filter 32 is 80 kHz (high mode shown in FIG. 8), the high-frequency reflection frequency can be detected with high accuracy. In this manner, when the filter 32 has a higher center frequency, detection performance is improved in an area with a higher reflection frequency, and when the filter 32 has a lower center frequency, detection performance is improved in a deeper area. The estimated depth value and the true value match well, which demonstrates the validity of this method.

### (Operation Example in First Embodiment)

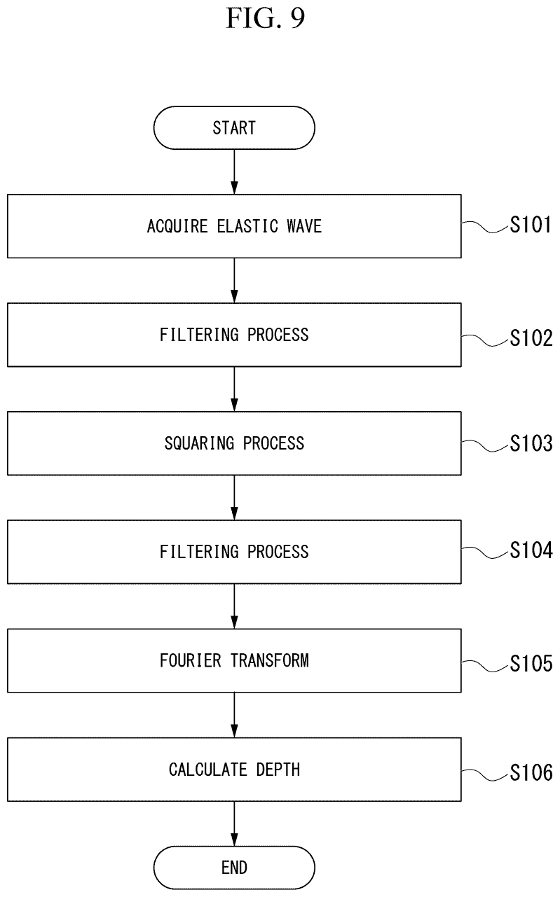

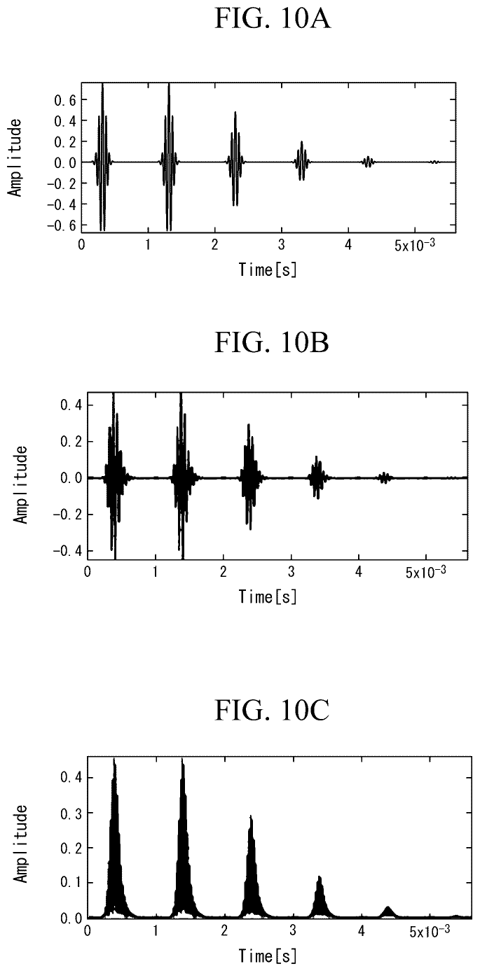

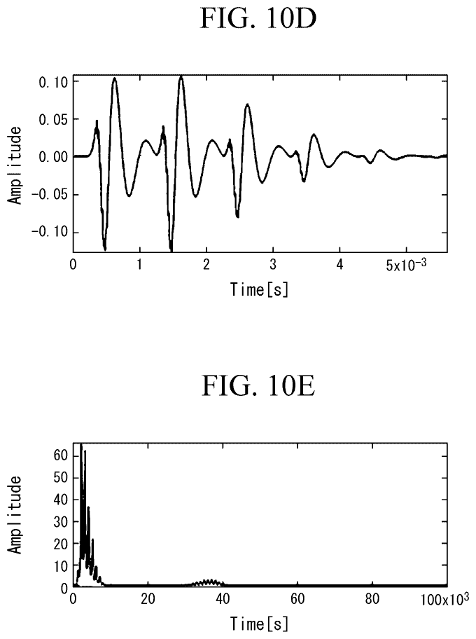

FIG. 9 is a flowchart showing a flow of a damage detection process performed by the damage detection apparatus 25 in the first embodiment. The process in FIG. 9 is executed when an impact is applied at a certain measurement point (for example, the position of damage) and an elastic wave is detected by the sensor 20. In addition, the process in FIG. 9 will be described with reference to a case in which the detector 33 includes the processor 35 and the filter 36. In addition, in the description of FIG. 9, FIG. 10 will be appropriately referred to. FIG. 10 shows diagrams of signal waveforms obtained according to a damage detection process performed by the damage detection apparatus 25 in the first embodiment.

The waveform acquirer 31 acquires an electrical signal based on the elastic wave generated by an impact applied at a certain measurement point according to the output from the sensor 20. The waveform acquirer 31 acquires waveform data at a certain measurement point by performing signal amplification, a filtering process and analog digital conversion on the acquired electrical signal (Step S101). FIG. 10A shows the waveform data obtained by this process. The waveform acquirer 31 outputs the acquired waveform data to the filter 32.

The filter 32 performs a filtering process on the waveform data at a certain measurement point output from the waveform acquirer 31 (Step S102). Thereby, the waveform data is converted into a narrowband signal. FIG. 10B shows the waveform data obtained by this process. The waveform data filtered by the filter 32 is input to the detector 33.

The processor 35 of the detector 33 performs a squaring process on the input waveform data (Step S103). FIG. 10C shows the waveform data obtained by this process. Here, the processor 35 may perform an absolute value process in place of the squaring process. Then, the processor 35 outputs the waveform data after the squaring process to the filter 36. The filter 36 performs a filtering process on the waveform data after the squaring process output from the processor 35 (Step S104). For example, the filter 36 detects an envelope of the waveform data after the squaring process and extracts an AC component of the detected envelope. Thereby, the AC component of the envelope of the waveform data after the squaring process is extracted. FIG. 10D shows the waveform data obtained by this process (for example, information indicating the AC component of the envelope). The waveform data filtered by the filter 36 is input to the outputter 34. The outputter 34 outputs transmission data including the input waveform data (for example, information indicating the AC component of the envelope) to the spectrum calculator 40.

The spectrum calculator 40 calculates a frequency spectrum obtained by performing a Fourier transform on the waveform data included in the transmission data output from the outputter 34 (Step S105). Thereby, the spectrum calculator 40 extracts a frequency spectrum, for example, as shown in FIG. 10E. The spectrum calculator 40 outputs information indicating the extracted frequency spectrum to the depth calculator 45. Here, the spectrum calculator 40 outputs information indicating the peak frequency as information indicating the frequency spectrum to the depth calculator 45. This peak frequency is the reflection frequency fᵣ.

The depth calculator 45 calculates the depth of damage based on the information indicating the frequency spectrum output from the spectrum calculator 40 (Step S106). Specifically, the depth calculator 45 calculates the depth of damage based on Formula (2) using a known elastic wave velocity Cₚ and the reflection frequency fᵣ calculated by the spectrum calculator 40. When there is damage at a position of a depth Tᵣ in the structure 50 with a thickness T, the thickness T calculated based on Formula (2) corresponds to the depth Tᵣ of damage.

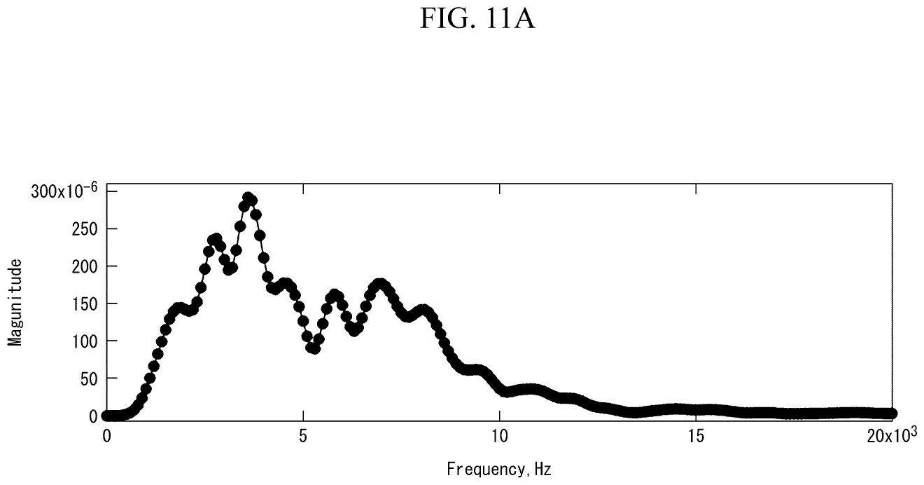

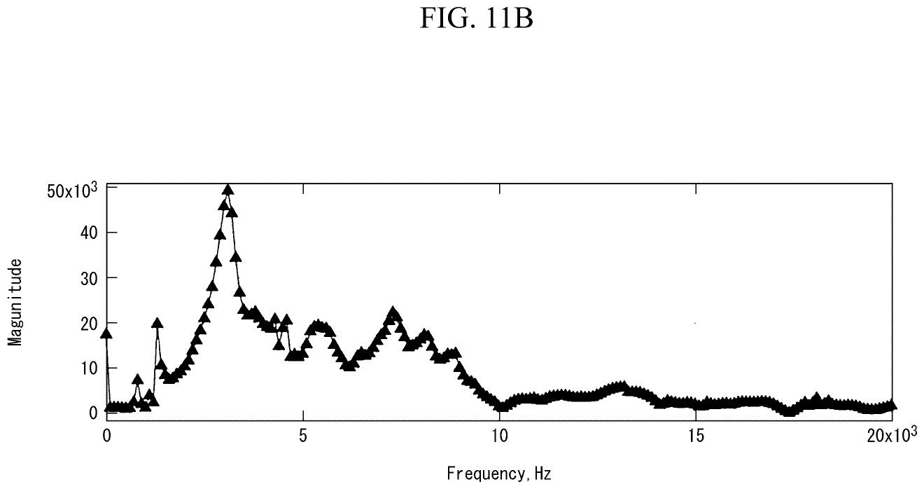

The depth of damage can be calculated by the above method. FIG. 11 shows the frequency spectra obtained by this method and the conventional impact echo method in an actual structure in order to demonstrate the effectiveness of this method. In this method, a 50 kHz resonance type AE sensor is used. FIG. 11A shows the frequency spectrum obtained by this method and FIG. 11B shows the frequency spectrum obtained by the conventional impact echo method. As shown in FIGS. 11A and 11B, the spectra match well, indicating that, by this method, the same reflection spectrum as in the impact echo method is obtained using an AE sensor with a resonant frequency higher than the reflection frequency band. By this method, the same sensor can be used for both AE measurement and impact echo measurement, and it is possible to reduce costs resulting from sensor installation.

The damage detection system 100 configured as described above includes the detector 33 configured to detect an AC component of an envelope using one or more elastic waves generated by an impact on the structure 50, the spectrum calculator 40 configured to calculate a frequency spectrum based on the detected AC component of the envelope, and the depth calculator 45 configured to calculate the depth of damage inside the structure 50 based on the frequency spectrum. Thereby, even if the sensor 20 with a resonant frequency higher than the reflection frequency band is used, the same reflection spectrum as in the conventional impact echo method can be obtained. Therefore, even if the sensor 20 with a resonant frequency higher than the reflection frequency band is used, the depth of damage inside the structure 50 can be calculated using the conventional impact echo method. In this manner, as the sensor used for estimating the depth of damage, other sensors can be used in place of a dedicated sensor. Therefore, it is possible to improve the degrees of freedom of the sensor used for estimating the depth of damage. In addition, since a dedicated sensor is not used, an inexpensive sensor can be used and sensor costs can be reduced.

In addition, in the damage detection system 100, regarding the center frequency of the filter 32, a frequency higher than the multiple reflection frequency calculated based on the thickness T of the structure 50 and the propagation velocity Cₚ of the elastic wave propagating inside the structure 50 is set as the center frequency. The detector 33 detects an AC component of an envelope using one or more elastic waves filtered by the filter 32. Thereby, even if a sensor having sensitivity at a high frequency such as an AE sensor is used, the reflection frequency can be calculated with high accuracy by the filter 32 performing conversion into a narrowband signal. Even if the sensor 20 having a resonant frequency higher than the reflection frequency band is used in this manner, the same reflection spectrum as in the conventional impact echo method can be obtained. Therefore, even if the sensor 20 having a resonant frequency higher than the reflection frequency band is used, the depth of damage inside the structure 50 can be calculated using the conventional impact echo method. In this manner, as the sensor used for estimating the depth of damage, other sensors can be used in place of a dedicated sensor. Therefore, it is possible to improve the degrees of freedom of the sensor used for estimating the depth of damage. In addition, since a dedicated sensor is not used, an inexpensive sensor can be used and sensor costs can be reduced.

In addition, in the damage detection system 100, the frequency band of the frequency spectrum that can be detected varies depending on the center frequency of the filter 32. Therefore, rather than using a fixed center frequency, by switching the center frequency of the filter 32 depending on the depth of damage to be detected, the depth of damage can be calculated with high accuracy.

### Second Embodiment

The first embodiment is effective when a position of damage occurring inside the structure is known. On the other hand, even if damage has occurred inside the structure, the position of damage occurring inside the structure is often unknown. Therefore, in a second embodiment, a configuration in which a process for identifying a damaged area is additionally performed will be described.

Here, the process for identifying a damaged area inside the structure is measured by, for example, a conventional acoustic emission (AE) method. As described in the first embodiment, even if a sensor having sensitivity at a high frequency such as an AE sensor is used, the depth of damage can be estimated using the impact echo method. The AE sensor is originally a sensor used for measurement by the AE method. Therefore, a sensor can be shared for both AE measurement and IE measurement (measurement by the impact echo method), the measurement operation time can be shortened and convenience can be improved.

In the second embodiment, first, planar measurement is performed using conventional AE measurement. Thereby, a damaged area is identified within an inspection target area surrounded by a plurality of sensors. Then, in the identified damaged area, the depth of damage is calculated by the method shown in the first embodiment. Thereby, both AE measurement and IE measurement can be performed using one type of sensor such as an AE sensor. Details will be described below.

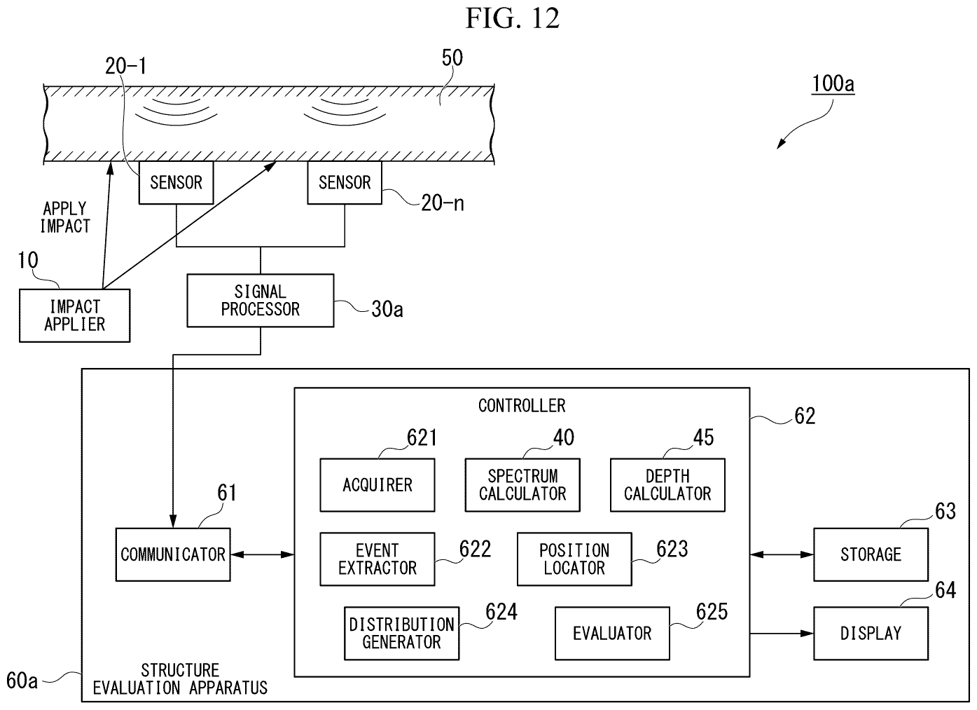

FIG. 12 is a diagram showing a configuration of a damage detection system 100a in the second embodiment. The damage detection system 100a is used to detect damage occurring inside the structure 50 and to evaluate the soundness of the structure 50. In the following description, the evaluation will refer to determination of the degree of soundness of the structure 50 based on certain criteria, that is, the deterioration state of the structure 50.

Damage that affects the evaluation of the deterioration state of the structure 50 is, for example, damage inside the structure, such as cracks, cavities, and sedimentation that inhibit propagation of elastic waves. Here, the cracks include a vertical crack, a horizontal crack, a diagonal crack, and the like. The vertical crack is a crack that occurs in a direction perpendicular to the road surface. The horizontal crack is a crack that occurs in a direction horizontal to the road surface. The diagonal crack is a crack that occurs in a direction other than the direction horizontal or perpendicular to the road surface. The sedimentation is deterioration in which concrete changes into a soil-like material, mainly at the boundary between an asphalt and a concrete floor slab.

The damage detection system 100a includes the impact applier 10, the plurality of sensors 20-1 to 20-n, a signal processor 30a, and a structure evaluation apparatus 60a. The plurality of sensors 20-1 to 20-n are each connected to the signal processor 30a in a wired manner so that they can communicate with each other. The signal processor 30a and the structure evaluation apparatus 60a are connected in a wired or wireless manner so that they can communicate with each other.

The damage detection system 100a has a different configuration from the damage detection system 100 in that the spectrum calculator 40 and the depth calculator 45 provided in the damage detection apparatus 25 are provided in the structure evaluation apparatus 60a, and the signal processor 30a is provided in place of the signal processor 30. The impact applier 10 and the sensor 20 are the same as those in the first embodiment. The following description will focus on differences from the first embodiment.

The signal processor 30a performs the same process as the signal processor 30 in the first embodiment. In addition, the signal processor 30a performs signal processing such as noise removal and extraction of elastic wave feature values on the input electrical signal. The signal processor 30a performs a first process of extracting an AC component of an envelope shown in the first embodiment and a second process of extracting a feature value used for AE measurement. The signal processor 30a operates by switching between the first process and the second process depending on the settings.

For example, when the signal processor 30a is set to perform the first process, it generates transmission data including information obtained by performing the first process (for example, information indicating the AC component of the envelope). The signal processor 30a outputs the generated transmission data to the structure evaluation apparatus 60a. For example, when the signal processor 30a is set to perform the second process, it generates transmission data including information obtained by performing the second process (for example, information indicating an elastic wave feature value and the like). The signal processor 30a outputs the generated transmission data to the structure evaluation apparatus 60a.

The signal processor 30a includes a digital circuit. The digital circuit is realized by, for example, an FPGA or a microcomputer. The digital circuit may be realized by a dedicated LSI. In addition, in the signal processor 30a, a non-volatile memory such as a flash memory or a removable memory may be installed. In the following description, a case in which the signal processor 30a includes a digital circuit will be described.

The structure evaluation apparatus 60a evaluates the deterioration state of the structure 50 based on the transmission data transmitted from the signal processor 30a. In addition, the structure evaluation apparatus 60a calculates the depth of damage based on the transmission data transmitted from the signal processor 30a. For example, the structure evaluation apparatus 60a has a first mode in which the deterioration state of the structure 50 is evaluated and a second mode in which the depth of damage is calculated. In this manner, the structure evaluation apparatus 60a can perform both AE measurement and IE measurement. The structure evaluation apparatus 60a includes an information processing apparatus such as a personal computer.

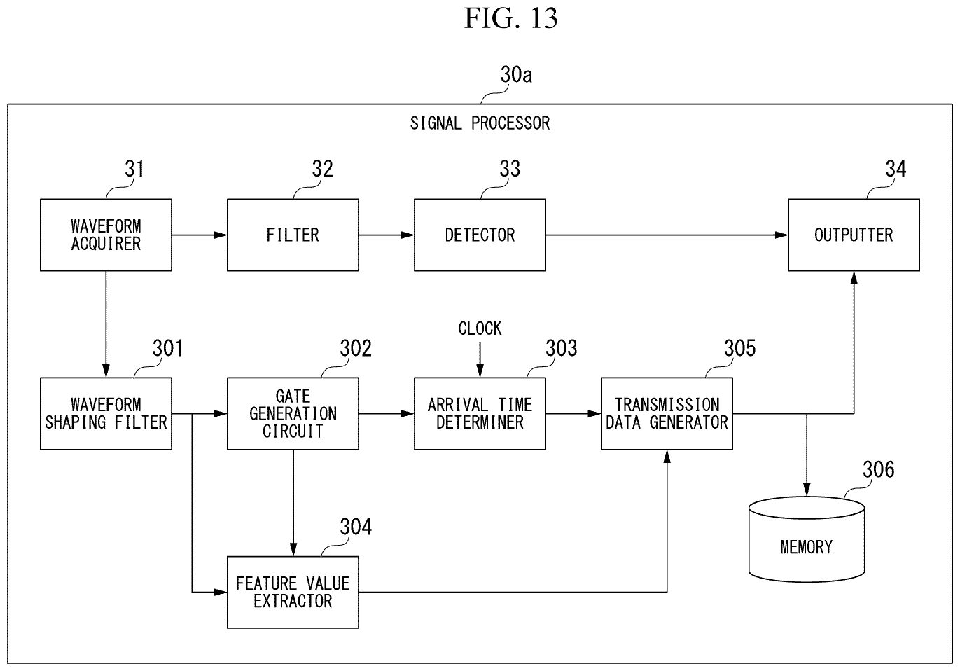

FIG. 13 is a diagram showing a configuration example of the signal processor 30a in the second embodiment. The signal processor 30a includes the waveform acquirer 31, the filter 32, the detector 33, the outputter 34, a waveform shaping filter 301, a gate generation circuit 302, an arrival time determiner 303, a feature value extractor 304, a transmission data generator 305, and a memory 306. The signal processor 30a has a different configuration from the signal processor 30 in that it additionally includes the waveform shaping filter 301, the gate generation circuit 302, the arrival time determiner 303, the feature value extractor 304, the transmission data generator 305 and the memory 306. The following description will focus on differences from the signal processor 30.

The waveform acquirer 31 has the same configuration as that shown in the first embodiment. When the waveform acquirer 31 is set to perform the first process, it outputs waveform data, which is a digital signal, to the filter 32, and when the waveform acquirer 31 is set to perform the second process, it outputs waveform data, which is a digital signal, to the waveform shaping filter 301.

The waveform shaping filter 301 removes a noise component outside a predetermined band from the waveform data, which is a digital signal output from the waveform acquirer 31. The waveform shaping filter 301 is, for example, a digital band pass filter (BPF). The waveform shaping filter 301 outputs the digital signal after the noise component has been removed (hereinafter referred to as a “noise-removed signal”) to the gate generation circuit 302 and the feature value extractor 304.

The gate generation circuit 302 receives the noise-removed signal output from the waveform shaping filter 301. The gate generation circuit 302 generates a gate signal based on the input noise-removed signal. The gate signal is a signal indicating whether the waveform of the noise-removed signal has been maintained.

The gate generation circuit 302 is realized by, for example, an envelope detecting unit and a comparator. The envelope detecting unit detects the envelope of the noise-removed signal. The envelope is extracted, for example, by squaring the noise-removed signal and performing a predetermined process (for example, a process using a low-pass filter or a Hilbert transform) on the squared output value. The comparator determines whether the envelope of the noise-removed signal is equal to or higher than a predetermined threshold value.

When the envelope of the noise-removed signal is equal to or higher than a predetermined threshold value, the gate generation circuit 302 outputs a first gate signal indicating that the waveform of the noise-removed signal has been maintained to the arrival time determiner 303 and the feature value extractor 304. On the other hand, when the envelope of the noise-removed signal is less than a predetermined threshold value, the gate generation circuit 302 outputs a second gate signal indicating that the waveform of the noise-removed signal has not been maintained to the arrival time determiner 303 and the feature value extractor 304. Here, the gate generation circuit 302 is configured to determine whether the waveform of the noise-removed signal has been maintained based on the envelope, but the gate generation circuit 302 may process the noise-removed signal itself or a signal to which an absolute value is applied. The threshold value used in the gate generation is referred to as a measurement threshold value.

The arrival time determiner 303 receives a clock output from a clock source such as a crystal oscillator (not shown) and a gate signal output from the gate generation circuit 302. The arrival time determiner 303 determines an elastic wave arrival time using the clock received while the first gate signal is received. The arrival time determiner 303 outputs the determined elastic wave arrival time as time information to the transmission data generator 305. The arrival time determiner 303 does not perform any processing while the second gate signal is received. The arrival time determiner 303 generates cumulative time information from when a power source is turned on based on a signal from the clock source. Specifically, the arrival time determiner 303 may be a counter that counts edges of a clock, and the value of the counter register may be used as time information. The counter register is determined to have a predetermined bit length.

The feature value extractor 304 receives the noise-removed signal output from the waveform shaping filter 301 and the gate signal output from the gate generation circuit 302. The feature value extractor 304 extracts the feature value of the noise-removed signal using the noise-removed signal received while the first gate signal is received. The feature value extractor 304 does not perform any processing while the second gate signal is received. The feature value is information indicating the feature of the noise-removed signal. That is, the feature value of the noise-removed signal is a feature value of the elastic wave detected by the sensor 20.

Examples of feature values include the amplitude [mV] of the waveform, the rise time [usec] of the waveform, the duration [usec] of the gate signal, the zero cross count number [times], the energy [arb.] of the waveform, the frequency [Hz] and the root mean square (RMS) value. The feature value extractor 304 outputs the extracted parameters related to feature values to the transmission data generator 305. When parameters related to feature values are output, the feature value extractor 304 associates the parameters related to feature values with a sensor ID. The sensor ID is identification information for identifying the sensor 20 installed in the area in which the soundness of the structure 50 is to be evaluated (hereinafter referred to as an “evaluation area”).

The amplitude of the waveform is, for example, the maximum amplitude value in the noise-removed signal. The rise time of the waveform is, for example, a time T1 from when the gate signal starts to rise until the noise-removed signal reaches the maximum value. The duration of the gate signal is, for example, a time from when the gate signal starts to rise until the amplitude becomes smaller than a preset value. The zero cross count number is, for example, the number of times the noise-removed signal crosses a reference line that passes through a zero value.

The energy of the waveform is, for example, a value obtained by time-integrating the squared amplitude of the noise-removed signal at each time point. Here, the definition of energy is not limited to the above example, and energy may be, for example, approximated using the envelope of the waveform. The frequency is the frequency of the noise-removed signal. The RMS value is, for example, a value obtained by squaring the amplitude of the noise-removed signal at each time point and taking the square root.

The transmission data generator 305 receives the sensor ID, the time information, and the parameters related to feature values. The transmission data generator 305 generates transmission data including the received sensor ID, time information, and parameters related to feature values.

The memory 306 stores one or more types of transmission data generated by the transmission data generator 305. The memory 306 is, for example, a dual-port random access memory (RAM)

The outputter 34 generates transmission data including information indicating the AC component of the envelope extracted by the detector 33. The outputter 34 transmits the generated transmission data to the structure evaluation apparatus 60a in a wired or wireless manner. In addition, the outputter 34 sequentially outputs one or more types of transmission data stored in the memory 306 to the structure evaluation apparatus 60a. For example, the signal processor 30a and the structure evaluation apparatus 60a are connected in a wired manner, the outputter 34 outputs the transmission data including information indicating the AC component of the envelope or one or more types of transmission data stored in the memory 306 to the structure evaluation apparatus 60a via a wired cable. When the signal processor 30a and the structure evaluation apparatus 60a are connected in a wireless manner, the outputter 34 outputs the transmission data including information indicating the AC component of the envelope or one or more types of transmission data stored in the memory 306 to the structure evaluation apparatus 60a in a wireless manner.

Description will now return to FIG. 12. The structure evaluation apparatus 60a includes a communicator 61, a controller 62, a storage 63, and a display 64.

The communicator 61 receives one or more types of transmission data transmitted from the signal processor 30a.

The controller 62 controls the entire structure evaluation apparatus 60a. The controller 62 includes a processor such as a central processing unit (CPU) and a memory. The controller 62 executes a program to function as the spectrum calculator 40, the depth calculator 45, an acquirer 621, an event extractor 622, a position locator 623, a distribution generator 624 and an evaluator 625.

Some or all of the functional units of the spectrum calculator 40, the depth calculator 45, the acquirer 621, the event extractor 622, the position locator 623, the distribution generator 624 and the evaluator 625 may be realized by hardware such as an application specific integrated circuit (ASIC), a programmable logic device (PLD), and an FPGA, or may be realized by software and hardware in cooperation. The program may be recorded in a computer-readable recording medium. The computer-readable recording medium is a non-transitory storage medium, for example, a portable medium such as a flexible disk, an optical disc, a read only memory (ROM), or a CD-ROM, or a storage apparatus such as a hard disk built in a computer system. The program may be transmitted via a telecommunications line.

Some of the functions of the spectrum calculator 40, the depth calculator 45, the acquirer 621, the event extractor 622, the position locator 623, the distribution generator 624 and the evaluator 625 do not need to be installed in the structure evaluation apparatus 60a in advance, and may be realized by installing an additional application program in the structure evaluation apparatus 60a.

The acquirer 621 acquires various types of information. For example, the acquirer 621 acquires one or more types of transmission data received by the communicator 61. The acquirer 621 stores the acquired one or more types of transmission data in the storage 63. The acquirer 621 acquires, for example, mode information designating the operation mode of the structure evaluation apparatus 60a. The structure evaluation apparatus 60a operates in either the first mode or the second mode based on the mode information acquired by the acquirer 621.

The spectrum calculator 40 and the depth calculator 45 are the same as those in the first embodiment. Here, the spectrum calculator 40 and the depth calculator 45 function when the structure evaluation apparatus 60a operates in the second mode.

The event extractor 622, the position locator 623, the distribution generator 624 and the evaluator 625 function when the structure evaluation apparatus 60a operates in the first mode.

The event extractor 622 extracts transmission data for one event from the plurality of types of transmission data stored in the storage 63. The event is an elastic wave generation event that occurs in the structure 50. In the present embodiment, the elastic wave generation event is, for example, application of an impact by the impact applier 10. When one event occurs, an elastic wave is detected at approximately the same time by the plurality of sensors 20. That is, the storage 63 stores transmission data related to the elastic wave detected at approximately the same time. Therefore, the event extractor 622 sets a predetermined time window and extracts all transmission data whose arrival time is within the time window range as transmission data for one event. The event extractor 622 outputs the extracted transmission data for one event to the position locator 623.

The time window range Tw may be determined using the elastic wave propagation velocity v in the target structure 50 and the maximum sensor interval dmax so that the range is Tw≥dmax/v. In order to avoid erroneous detection, since it is desirable to set Tw to as small a value as possible, substantially Tw=dmax/v can be achieved. The elastic wave propagation velocity v may be determined in advance.

The position locator 623 determines the position of the elastic wave source based on sensor position information and the sensor ID and time information included in each of the plurality of types of transmission data extracted by the event extractor 622.

The sensor position information includes information on the installation position of the sensor 20 in association with the sensor ID. The sensor position information includes information on the installation position of the sensor 20, for example, the latitude and longitude, or the distances in the horizontal direction and the vertical direction from a reference position of the structure 50. The position locator 623 stores the sensor position information in advance. The sensor position information may be stored in the position locator 623 at any timing before the position locator 623 determines the position of the elastic wave source.

The sensor position information may be stored in the storage 63. In this case, the position locator 623 acquires the sensor position information from the storage 63 at a timing of determining the position. A Kalman filter, a least squares method or the like may be used to determine the position of the elastic wave source. The position locator 623 outputs position information of the elastic wave source obtained during an evaluation target period to the distribution generator 624.

The distribution generator 624 receives the position information of the plurality of elastic wave sources output from the position locator 623. The distribution generator 624 generates an elastic wave source distribution using the received position information of the plurality of elastic wave sources. The elastic wave source distribution is a distribution showing the positions of elastic wave sources. More specifically, the elastic wave source distribution is a distribution in which the horizontal axis represents the distance in the passing direction, the vertical axis represents the distance in the width direction, and points indicating the positions of the elastic wave sources are shown on virtual data representing the structure 50 to be evaluated.

The distribution generator 624 generates an elastic wave source density distribution using the elastic wave source distribution. The elastic wave source density distribution is a distribution in which density values determined according to the number of elastic wave sources included in each area are shown for each predetermined area in the elastic wave source distribution. Specifically, first, the distribution generator 624 divides the elastic wave source distribution into a plurality of areas by separating it into predetermined sections. Next, the distribution generator 624 calculates the density for each divided area generated by division. For example, the distribution generator 624 calculates the density for each divided area by dividing the number of elastic wave sources located within the divided area by the area of the divided area. Then, the distribution generator 624 generates an elastic wave source density distribution by allocating the calculated density value for each divided area to each divided area. In this manner, the distribution generator 624 generates an elastic wave source density distribution by calculating the density of the evaluation target area.

The evaluator 625 evaluates the deterioration state of the structure 50 using the elastic wave source density distribution generated by the distribution generator 624. For example, the evaluator 625 evaluates an area in which the density of elastic wave sources is equal to or higher than a threshold value in the elastic wave source density distribution as a healthy area, and evaluates an area in which the density of elastic wave sources is less than a threshold value as a damaged area. The healthy area is an area where no damage has occurred inside the structure 50 or even if damage has occurred, the damage is relatively small.

The storage 63 stores one or more types of transmission data acquired by the acquirer 621. The storage 63 includes a storage apparatus such as a magnetic hard disk device or a semiconductor storage apparatus. Here, the storage 63 may also store the evaluation results obtained by the evaluator 625.

The display 64 displays the evaluation results under control of the evaluator 625. For example, the display 64 may display, as the evaluation result, whether deterioration has occurred inside the structure 50, or may display an area where deterioration occurs on the elastic wave propagation velocity distribution. The display 64 is an image display apparatus such as a liquid crystal display or an organic electro luminescence (EL) display. The display 64 may be an interface for connecting the image display apparatus to the structure evaluation apparatus 60a. In this case, the display 64 generates a video signal for displaying the evaluation result and outputs the video signal to the image display apparatus connected thereto.

### (Operation Example in Second Embodiment)

Next, an operation example of the damage detection system 100a in the second embodiment will be described. In the damage detection system 100a, first, AE measurement is performed. Therefore, the signal processor 30a is set to perform the second process, and the structure evaluation apparatus 60a is set to operate in the first mode. The signal processor 30a receives the digital signal output from the analog-to-digital converting unit. The arrival time determiner 303 of the signal processor 30a determines the arrival time of each elastic wave. Specifically, the arrival time determiner 303 determines an elastic wave arrival time using a clock input while the first gate signal is received. The arrival time determiner 303 outputs the determined elastic wave arrival time as time information to the transmission data generator 305. The arrival time determiner 303 performs this process on all input digital signals.

The feature value extractor 304 of the signal processor 30a extracts the feature value of the noise-removed signal using the noise-removed signal, which is a digital signal input while the first gate signal is received. The feature value extractor 304 outputs parameters related to the extracted feature values to the transmission data generator 305. The transmission data generator 305 generates transmission data including a sensor ID, time information, and parameters related to feature values. The transmission data generator 305 stores the generated transmission data in the memory 306. The outputter 34 sequentially outputs the transmission data stored in the memory 306 to the structure evaluation apparatus 60a.

The communicator 61 of the structure evaluation apparatus 60a receives the transmission data output from the signal processor 30a. The acquirer 621 acquires the transmission data received by the communicator 61. The acquirer 621 records the acquired transmission data in the storage 63. The acquirer 621 records all the transmission data received during the evaluation target period in the storage 63. After the evaluation target period has elapsed or in response to an external instruction, the event extractor 622 extracts transmission data for one event from transmission data for the evaluation target period stored in the storage 63. The event extractor 622 outputs the extracted transmission data for one event to the position locator 623. The event extractor 622 performs a process of extracting transmission data for one event and a process of outputting the extracted transmission data for one event in chronological order.

The position locator 623 determines the position of the elastic wave source based on the sensor ID and time information included in the transmission data output from the event extractor 622 and the sensor position information stored in advance. Specifically, first, the position locator 623 calculates the difference in the arrival time of the elastic waves to the plurality of sensors 20. Next, the position locator 623 determines the position of the elastic wave source using the sensor position information and information on the difference in the arrival time.

The position locator 623 determines the position of the elastic wave source whenever transmission data for one event is output from the event extractor 622 during the evaluation target period. Thereby, the position locator 623 determines the positions of the plurality of elastic wave sources generated during the evaluation target period. The position locator 623 outputs the position information of the plurality of elastic wave sources to the distribution generator 624.

The distribution generator 624 generates an elastic wave source distribution using the position information of the plurality of elastic wave sources output from the position locator 623. Specifically, the distribution generator 624 generates an elastic wave source distribution by plotting positions of elastic wave sources indicated by the obtained position information of the plurality of elastic wave sources on virtual data. The distribution generator 624 generates an elastic wave source density distribution using the generated elastic wave source distribution. The distribution generator 624 outputs the generated elastic wave source density distribution to the evaluator 625.

The evaluator 625 evaluates the deterioration state of the structure 50 using the elastic wave source density distribution output from the distribution generator 624. The evaluator 625 outputs the evaluation results to the display 64. The display 64 displays the evaluation results output from the evaluator 625. By looking at the evaluation results displayed on the display 64, an operator of the damage detection system 100a can identify an area where deterioration occurs within the evaluation target area. Therefore, the operator calculates the depth of damage in the area where deterioration occurs by the method shown in the first embodiment.

In this case, in the damage detection system 100a, next, IE measurement is performed. Therefore, the signal processor 30a is set to perform the first process, and the structure evaluation apparatus 60a is set to operate in the second mode. The basic operation is the same as that shown in the first embodiment. Therefore, the differences will be described here. After the process of Step S104, the outputter 34 transmits transmission data including the input waveform data (for example, information indicating the AC component of the envelope) to the structure evaluation apparatus 60a in a wired or wireless manner.

The communicator 61 of the structure evaluation apparatus 60a receives the transmission data output from the signal processor 30a. The acquirer 621 outputs the transmission data received by the communicator 61 to the spectrum calculator 40. The spectrum calculator 40 calculates a frequency spectrum obtained by performing a Fourier transform on the waveform data included in the transmission data output from the acquirer 621. The spectrum calculator 40 outputs information indicating the extracted frequency spectrum to the depth calculator 45. The depth calculator 45 calculates the depth of damage based on the information indicating the frequency spectrum output from the spectrum calculator 40.

According to the damage detection system 100a configured as described above, the same effects as in the first embodiment can be obtained.

In addition, in the damage detection system 100a, both IE measurement and AE measurement can be performed based on the elastic wave detected by the same sensor 20. Therefore, it is not necessary to use a dedicated sensor for IE measurement, and the number of sensors used for measurement can be reduced. Therefore, it is possible to reduce sensor costs. In addition, in the damage detection system 100a, since IE measurement and AE measurement can be performed, it is possible to improve convenience.

### Modification Example 1 in Second Embodiment

Some or all of the functional units of the structure evaluation apparatus 60a may be provided in another apparatus. For example, the display 64 of the structure evaluation apparatus 60a may be provided in another apparatus. In such a configuration, the structure evaluation apparatus 60a transmits the evaluation result to the other apparatus including the display 64. The other apparatus including the display 64 displays the received evaluation result.

### Modification Example 2 in Second Embodiment

In the above configuration, the structure evaluation apparatus 60a is configured to perform both AE measurement and IE measurement. The structure evaluation apparatus 60a may be configured to perform only AE measurement, and IE measurement may be performed by another apparatus. In such a configuration, the structure evaluation apparatus 60a does not need to include the spectrum calculator 40 and the depth calculator 45, and does not need to have the second mode for performing IE measurement. The other apparatus may be, for example, the damage detection apparatus 25 as in the first embodiment, or may be an information processing apparatus different from the damage detection apparatus 25. When the spectrum calculator 40 and the depth calculator 45 are provided in the damage detection apparatus 25, the signal processor 30a transmits transmission data to the spectrum calculator 40 during the first process, and transmits transmission data to the structure evaluation apparatus 60a during the second process.

### Modification Example 3 in Second Embodiment

In the above configuration, the structure evaluation apparatus 60a is configured to evaluate the deterioration state of the structure, but the operator can also identify the area where deterioration occurs by looking at the elastic wave source density distribution. Therefore, the structure evaluation apparatus 60a does not evaluate the deterioration state of the structure 50 based on the elastic wave source density distribution, but may display the elastic wave source density distribution on the display 64. In such a configuration, the structure evaluation apparatus 60a does not need to include the evaluator 625. The operator identifies the area where deterioration occurs with reference to the elastic wave source density distribution displayed on the display 64 of the structure evaluation apparatus 60a, operates the structure evaluation apparatus 60a, and thus may calculate the depth of damage shown in the first embodiment in the area where deterioration occurs.

### Modification Example 4 in Second Embodiment

In the above configuration, the structure evaluation apparatus 60a is configured to evaluate the deterioration state of the structure based on the elastic wave source density distribution. In this method, since it is sufficient to identify the area where deterioration occurs, the method by which the structure evaluation apparatus 60a evaluates the deterioration state of the structure is not limited to the above method. For example, a conventional method based on the elastic wave propagation velocity may be used, a method of evaluating the deterioration state of the structure 50 by combining the elastic wave propagation velocity distribution and the elastic wave source density distribution according to the method described in the following Reference Document 1 may be used, or other methods may be used.
(Reference Document 1: WO 2017/199542)

In the method described in Reference Document 1, at least four levels of evaluation results are obtained. Therefore, the operator need only determine in which area an evaluation result is obtained in order to calculate the depth of damage based on the obtained four levels of evaluation results.

### Modification Example 5 in Second Embodiment

The signal processor 30a may be integrated with the structure evaluation apparatus 60a. That is, the structure evaluation apparatus 60a may have all functions performed by the signal processor 30a.

### Modification Example 1 Common to First Embodiment and Second Embodiment

In each of the above embodiments, a configuration in which the plurality of sensors 20-1 to 20-n are connected to one signal processor 30 is shown. The damage detection systems 100 and 100a may include the plurality of signal processors 30 and 30a, and the sensors 20 may be connected to different signal processors 30 and 30a. In this case, the plurality of signal processors 30 and 30a perform a process based on the elastic waves detected by the sensors 20 to which they are connected.

According to at least one of the above embodiments, when the detector 33 configured to detect an AC component of an envelope using one or more elastic waves generated by an impact on the structure 50, the spectrum calculator 40 configured to calculate a frequency spectrum based on the detected AC component of the envelope, and the depth calculator 45 configured to calculate the depth of damage inside the structure 50 based on the frequency spectrum are provided, it is possible to improve the degrees of freedom of the sensor used to estimate the depth of damage and reduce sensor costs.

Some processes performed by the signal processor 30 in the above embodiment may be realized by a computer. In this case, a program for realizing this function is recorded in a computer-readable recording medium, and a computer system reads and executes the program recorded in the recording medium for realization. Note that the “computer system” here includes an OS and hardware such as peripheral devices. In addition, the “computer-readable recording medium” refers to a portable medium such as a flexible disk, an optical disc, a ROM, and a CD-ROM, and a storage apparatus such as a hard disk built into the computer system. In addition, the “computer-readable recording medium” may include a medium that dynamically maintains a program for a short time like a communication line when a program is transmitted via a network such as the Internet or a communication line such as a telephone line, and a medium that maintains a program for a certain time like a volatile memory in the computer system serving as a server or a client in that case. In addition, the program may be a program for realizing some of the above functions, may be capable of realizing the above functions in combination with a program already recorded in the computer system, or may be realized using a programmable logic device such as an FPGA.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A damage detection apparatus, comprising:
a detector configured to detect an Alternating Current (AC) component of an envelope using one or more elastic waves generated by an impact on a structure;
a spectrum calculator configured to calculate a frequency spectrum based on the detected AC component of the envelope; and
a depth calculator configured to calculate a depth of damage inside the structure based on the frequency spectrum.

2. The damage detection apparatus according to claim 1, further comprising
a first band pass filter in which a frequency higher than a multiple reflection frequency calculated based on a thickness of the structure and a propagation velocity of an elastic wave propagating inside the structure is set as a center frequency, and which performs a filtering process on the one or more elastic waves,
wherein the detector detects the AC component of the envelope using the one or more elastic waves filtered by the first band pass filter.

3. The damage detection apparatus according to claim 1,
wherein the detector includes
a processor configured to perform a process of obtaining an absolute value or a square of the one or more elastic waves, and
a second band pass filter configured to detect an envelope using the one or more elastic waves processed by the processor and detect an AC component of the detected envelope.

4. The damage detection apparatus according to claim 1,
wherein the detector includes
a converter configured to perform a Hilbert transform on the one or more elastic waves, and
a high-pass filter configured to remove a Direct Current (DC) component of the envelope obtained by the Hilbert transform.

5. The damage detection apparatus according to claim 2,
wherein the first band pass filter switches the center frequency according to the depth of damage calculated by the depth calculator.

6. The damage detection apparatus according to claim 1,
wherein the one or more elastic waves are signals detected by a resonance type AE sensor.

7. The damage detection apparatus according to claim 6,
wherein the resonance type AE sensor is a sensor with a resonant frequency of 10 kHz to 100 kHz.

8. The damage detection apparatus according to claim 2,
wherein the bandwidth of the first band pass filter is 100 Hz or more.

9. A damage detection system, comprising:
an impact applier configured to apply an impact to a structure;
one or more sensors configured to detect one or more elastic waves generated by the impact applied by the impact applier;
a detector configured to detect an Alternating Current (AC) component of an envelope using one or more elastic waves generated by an impact on a damaged area inside the structure estimated based on the one or more elastic waves detected by the one or more sensors;
a spectrum calculator configured to calculate a frequency spectrum based on the detected AC component of the envelope; and
a depth calculator configured to calculate a depth of damage inside the structure based on the frequency spectrum.

10. A damage detection method, comprising:
detecting an Alternating Current (AC) component of an envelope using one or more elastic waves generated by an impact on a structure;
calculating a frequency spectrum based on the detected AC component of the envelope; and
calculating the depth of damage inside the structure based on the frequency spectrum.
